(19) United States
(12) Patent Application Publication
(10) Pub. No.: US 2011/0180353 A1
(43) Pub. Date: Jul. 28, 2011

(54) ELECTROMECHANICAL DOOR LOCKS FOR LIFTS

(76) Inventor: Tim Askins, Mt. Pleasant, SC (US)

(21) Appl. No.: 12/694,545

(22) Filed: Jan. 27, 2010

(51) Int. Cl. B66B 13/16

(52) U.S. Cl. 187/331

(57) ABSTRACT

An electromechanically actuated safety lock mechanism particularly suited for elevator hall doors, dumb waiters, and similar lift mechanisms and other applications. A door lock and switch comprises a fixed contact member that is attached to a movable door and a movable locking mechanism attached to a door jamb or second moving door. The locking mechanism may comprise, an involute gear and star wheel, a pawl constrained by a torsion spring and an electromechanical means of actuating same.

### FIELD OF THE INVENTION

This invention relates to interlocks generally, and is more particularly related to electromechanically operated locks that are useful in lifting devices such as elevators, lifts and dumb waiters.

### BACKGROUND

Elevator landing door locks, which are commonly referred to as interlocks, are provided in elevator systems to lock hall doors against movement when the elevator car is not in position to receive loads. The interlock is a safety device that prevents access to an elevator shaft through the doors when the car is not present in the doorway. The interlock also prevents the elevator cab from moving before the door is closed and locked. Safety locks are required by numerous building safety codes.

Interlocks in common use with lifting devices are controlled by solenoids. While generally dependable, solenoids require a large coil to have sufficient power to engage and hold the locking mechanism in the ‘open’ position. The size of the coils that comprise these systems require that interlocks be bulky and unsightly when compared to most residential door locking mechanisms. These locks are commonly ‘normally closed’, such as by spring biasing, and rely on being energized to maintain an ‘open’ position. This design can prevent the hall door from being closed if the hall door is open and there is a power failure, since gravity moves the interlock into the ‘closed’ position, preventing the door from reclosing. There is a need for a device that will permit easy locking of the door if the operating device is not powered.

### SUMMARY OF THE INVENTION

The present invention is a lifting device door latch and switch mechanism that permits a lifting device, such as an elevator, to move only when the car door is closed and locked, preventing access to the elevator shaft when the elevator car is not at the floor level of the door of the shaft. The device provides a positive holding mechanism that prevents inadvertent movement of the door once locked. A self-latching device locks access to hall doors in the event of loss of power to the device. The device may be used on multiple floor levels, and when any one of the doors is open, movement of the elevator is disabled.

### BRIEF DESCRIPTION OF THE DRAWINGS

FIG. 1 is an exploded view of the latch, locking mechanism and cover of an embodiment of the invention.

FIG. 2 is an isometric view of a latch and locking mechanism of an embodiment of the invention showing an ‘open’ position (FIG. 2A) and a ‘closed’ position (FIG. 2B).

FIG. 3 is a sequence of isometric cutaway views of the back of a latch of an embodiment of the invention progressively depicting the interaction of the star-wheel, gear, pawl and the keeper in self-latching action.

FIG. 4 is an isolation of a drive shaft that may be used with the invention.

FIG. 5 is an isolation of a servo motor that may be used with the invention.

FIG. 6 is an isolation of a torsion spring that may be used with the invention.

FIG. 7 is an isolation of a back side of a gear that may be used with the invention.

FIG. 8 is an isolation of a front side of a gear that may be used with the invention.

FIG. 9 is an isolation of a pawl that may be used with the invention.

FIG. 10 is an isolation of a keeper that may be used with the invention.

### DETAILED DESCRIPTION OF THE PREFERRED EMBODIMENTS

For purposes of illustration, the electrical components that are associated with this device are not shown in detail. The device is incorporated into known lifting devices, and is connected to a power source, signaling devices and switching devices as used with lifting devices.

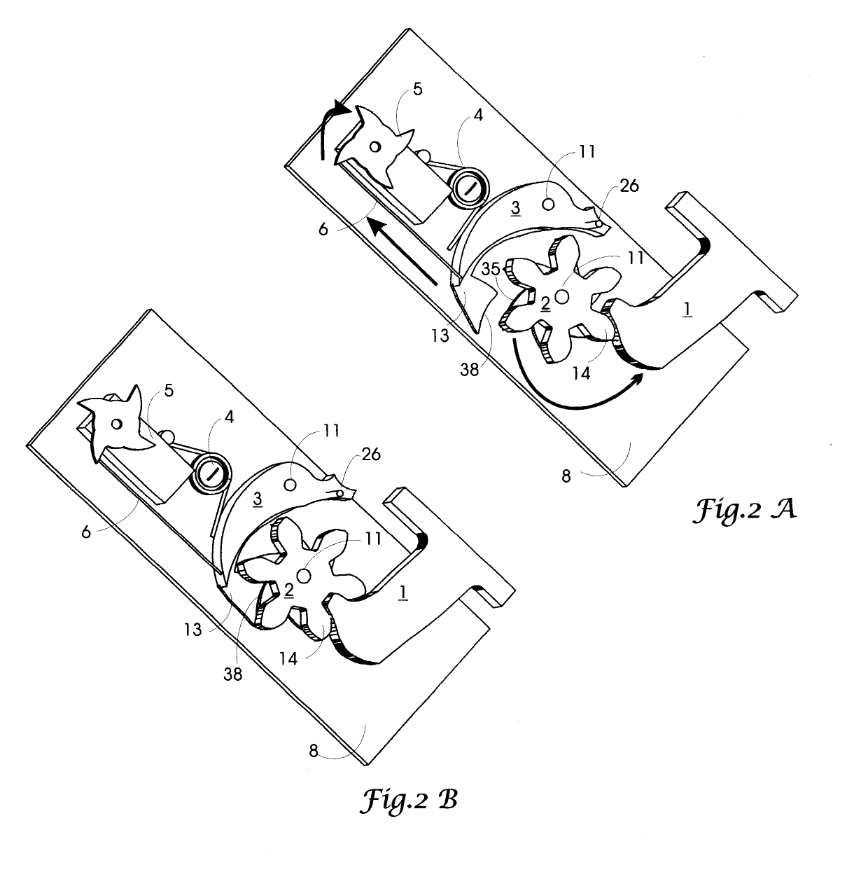

Turning to the drawing figures, in a preferred embodiment, gear 2 is supported on the housing back plate 8, and is rotatable about a stationary vertical pin 11, which acts as an axle. FIGS. 2A and 2B. The gear is constrained in the ‘locked’ position by spring biasing, which may be provided by a torsion spring 4. The gear 2 may be constructed from a variety of materials, and in one embodiment is formed of a hard resilient material such as Acetal. The gear as shown has a central bore that receives pin 11, allowing the gear to rotate about the pin. The gear may be of a daisy shape as shown in the drawing figures, with angularly spaced teeth 14, and having intervening pockets that may be formed on the top side around the periphery of the gear 2. FIG. 8. The pockets are preferred to be formed and adapted to a size and shape that accepts the tooth 16 of the keeper 1. In this embodiment, a bottom portion of the gear 36 is formed in a star or pinwheel shape having teeth 34 and pockets corresponding to the teeth of the top gear. FIG. 7 and FIG. 8. However, the lower gear may be provided as a separate part coupled to the top part of the gear 11, preferably with a square axle.

The pawl 3 is similarly preferred to be constructed with a bore offset from the center to provide a pivot point and likewise secured with a pin 11 allowing the pawl to pivot. The tail 13 of the pawl may be shaped to correspond to and match the curved face of the star wheel, so that when it rests on the convex surface 35 (FIG. 7) the angular tip of the tooth 34 (FIG. 7) engages the concave face 38 of the tail. The pawl 3 is restrained towards the gear by spring biasing such as torsion spring 4, forcing the pawl and star wheel to engage, and preventing the gear from moving in a counterclockwise direction.

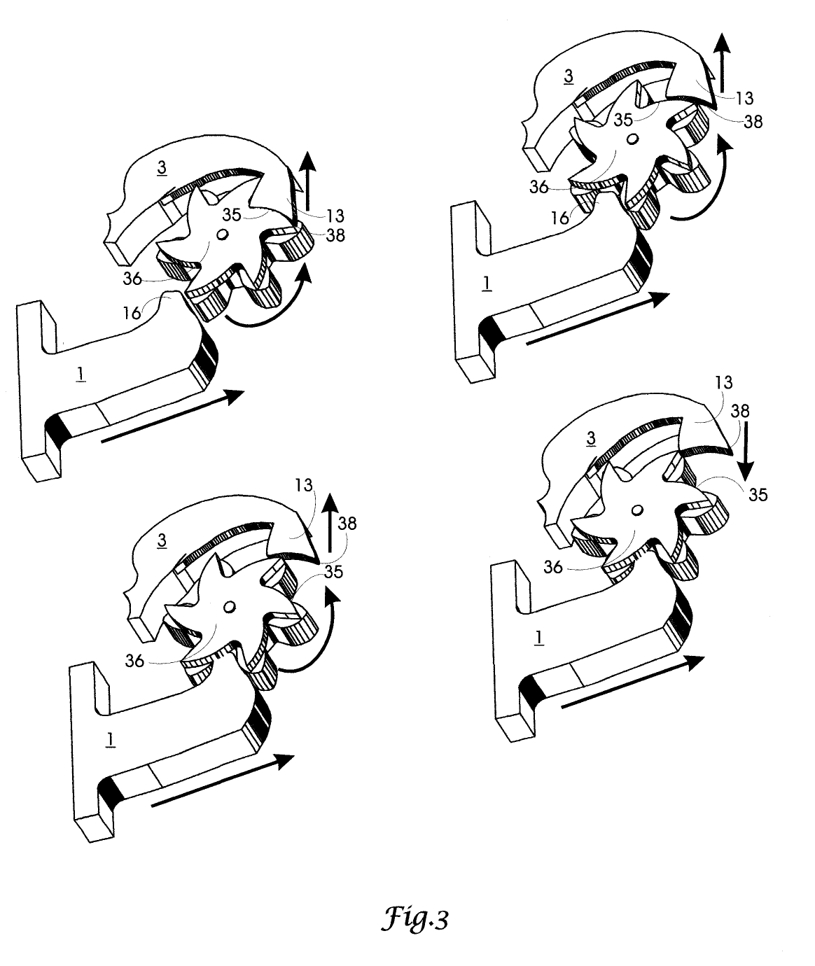

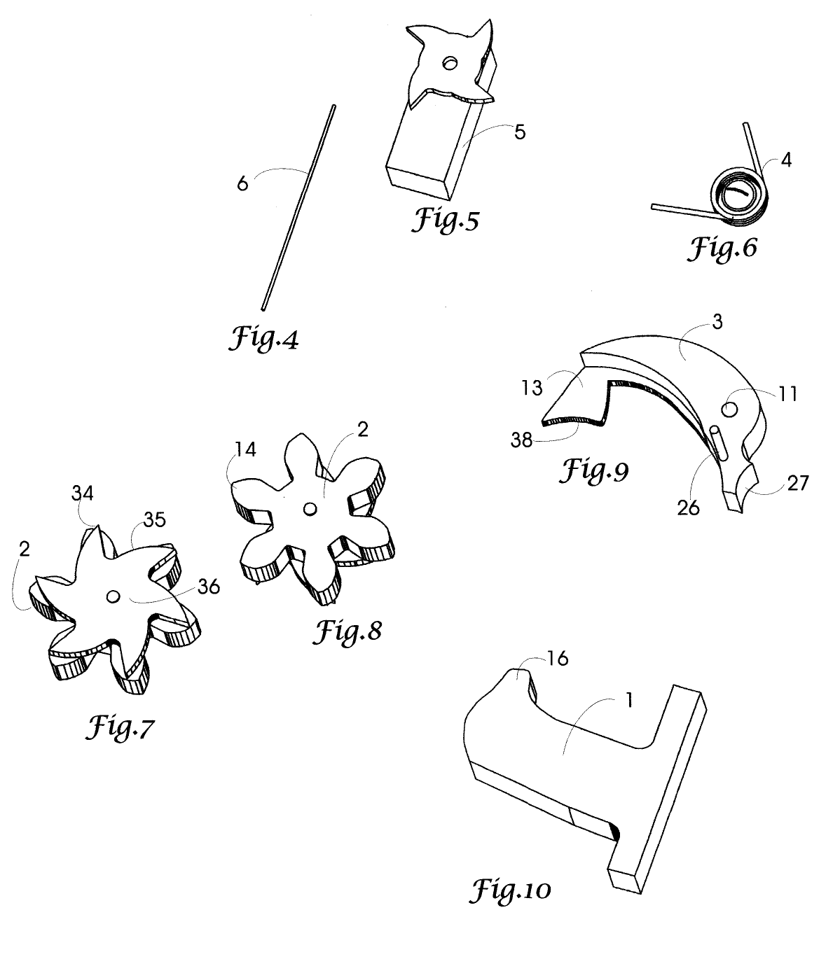

An electrically actuated or electromechanical actuator, such as a servo motor 5 or a solenoid, may be positioned with a drive shaft 6 attached to the tail of the pawl 3. When the device is energized it forces the pawl to move away from the star wheel, allowing the gear to turn freely, and allowing the keeper to retract from the gear pocket into the ‘open’ position. When the actuator is de-energized, spring 4 urges the pawl to return to the ‘closed’ position. Thereafter, the keeper 1 re-engages the gear while the pawl 3 is engaged with the star wheel 36. The shape of the star wheel 36 and the offset pivot of the tail of the pawl 3 are such that the pawl is forced to ride along the curved face 35 of the star wheel 36. FIG. 7. This action allows the gear 2 to turn in a clockwise direction accepting the pinion on the keeper and holding it securely in the ‘closed’ position. The action is illustrated in the progressive sequence shown in FIG. 3.

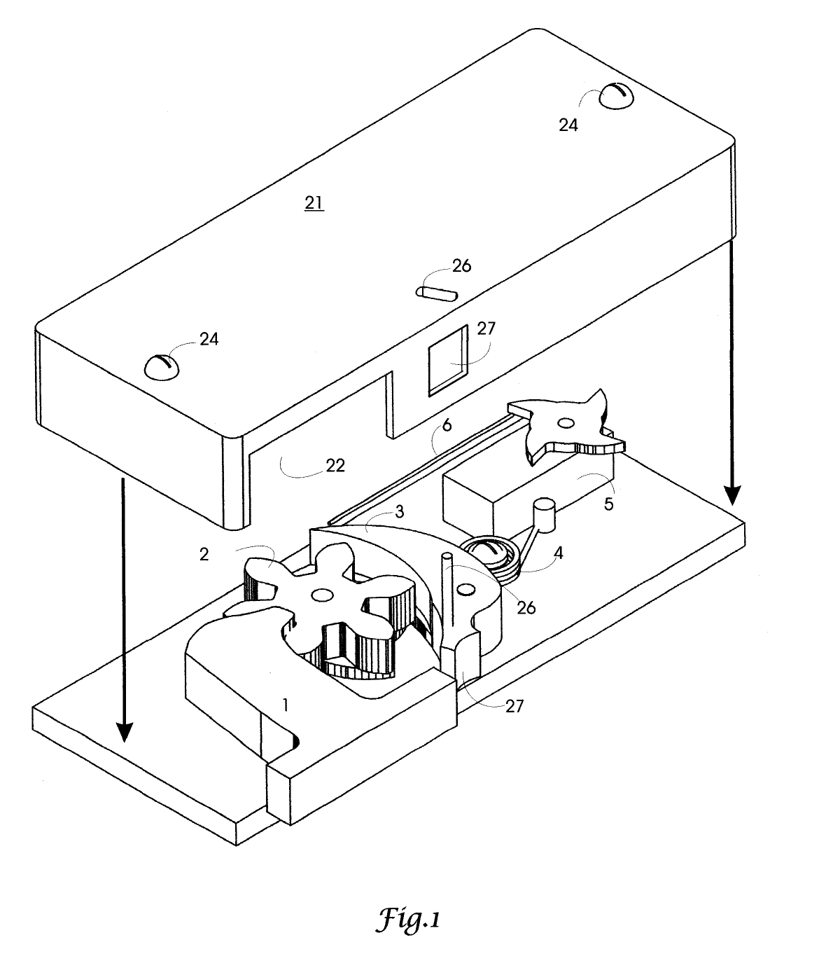

The protective cover 21 (FIG. 1) is formed to slip fit over the base. It has openings formed to correspond with the engagement of the keeper 101 and access to the manual releases. 26 and 27. Manual release 26 is accessed from inside the car while handle 27 of the pawl may be accessed through an opening in the hallway door. These releases are positioned relative to the pivot point and the cover to allow manual pivoting and release of the pawl from the gear 2. As shown, the cover 21 is secured with screws 24.

The resulting interlock provides an electro-mechanical means for locking the door closed. The keeper is attached to a hall door and the backing plate 8 and associated devices are attached to the hall door jamb. Signaling devices associated with the elevator or lifting device control system control the actuator or servo. The resulting interlock holds the hallway door secure, and prevents the interruption of the safety signal. Interruption of the safety signal causes failure of the call system and prevents use and access to the car. The devices also provides means for locking the door in the event of a power interruption, but allows the door to close and lock regardless of the location of the locking mechanism at the time of the power interruption.

The embodiment of the invention as shown utilizes a ratcheting mechanism permitting motion in one direction but not the other. In this ratchet mechanism, the rotary motion about the axes are enabled for relative motion in one direction, but the pawl engages the star wheel to prevent relative motion in the other direction.

The electromechanical device of the invention may utilize either AC or DC as a power source. The device may be provided to work with any elevator system or lifting system that relies on a door latch and which can receive and transmit an electrical signal from any type of controller.

A manual override of the lock for emergency use may be provided. In the event of a power loss a battery back-up power supply may be provided to release the door lock and allow passengers to exit the elevator car. There is also an additional provision for a radio controlled remote activation of the lock for emergency release of the lock.

The invention provides a universal type lock that is not left or right handed and does not require internal reconfiguration. This feature reduces the costs of stocking specific locks for doors that open to the left or right. Further the installer or repairman is not required to reconfigure the internal components of the lock, enabling easy configuration in the field and reducing opportunities for errors in the installation/repair of locks.

The invention provides a mechanism that can be readily manufactured in a variety of means such as tamped metal, castings in metal, plastics or composites or CNC machined parts to suit the manufacturer's preferences and processes.

What is claimed is:

1. An interlock for a lifting device, comprising:
a rotating gear, wherein said rotating gear comprises a plurality of teeth, wherein said teeth are formed to receive and hold a door keeper between said teeth,
a spring biased and pivoting pawl that engages said teeth of said gear,
an electrically operated actuator, wherein said electrically operator actuator is connected to said spring biased pawl,
wherein, in use, said spring biased and pivoting pawl engages said rotating gear and prevents rotation of said gear, and holds a keeper within said teeth of said rotating gear, and upon actuation of said electrically operated actuator, said electrically operated actuator disengages said pawl from said rotating gear, allowing said rotating gear to rotate and disengage said keeper, and wherein the keeper is capable of engaging said gear when said pawl is engaged with said gear, but the keeper is not capable of disengaging from said gear when said pawl is engaged with said gear.

2. An interlock for a lifting device as described in claim 1, wherein said rotating gear comprises a bottom portion comprising a plurality of teeth, and a top portion that overlays said bottom portion, said top portion having a corresponding number of teeth to said bottom portion, wherein the keeper engages said teeth of said top portion of said gear and said pawl engages said teeth of said bottom portion of said gear.

3. An interlock for a lifting device as described in claim 1, wherein said spring biased and pivoting pawl comprises a tail that is positioned opposite a pivot point of said pawl, wherein said rotating gear comprises a bottom portion comprising a plurality of teeth, and a top portion that overlays said bottom portion, said top portion having a corresponding number of teeth to said bottom portion, wherein the keeper engages said teeth of said top portion of said gear and said tail of said pawl is formed to engage said teeth of said bottom portion of said gear.

4. An interlock for a lifting device as described in claim 1, wherein said rotating gear comprises a star shaped bottom portion comprising a plurality of teeth, and a daisy shaped top portion that overlays said bottom portion, said top portion having a corresponding number of teeth to said bottom portion, wherein the keeper engages said teeth of said top portion of said gear and said pawl engages said teeth of said bottom portion of said gear.

5. An interlock for a lifting device as described in claim 1, wherein said spring biased and pivoting pawl comprises a tail that is positioned opposite a pivot point of said pawl, wherein said rotating gear comprises a star shaped bottom portion comprising a plurality of teeth, and a daisy shaped top portion that overlays said bottom portion, said top portion having a corresponding number of teeth to said bottom portion, wherein the keeper engages said teeth of said top portion of said gear and said tail of said pawl comprises a concave surface that is formed to engage a corresponding convex surface of said teeth of said star shaped bottom portion of said gear.

6. An interlock for a lifting device as described in claim 1, wherein said electrically operated actuator moves in a first direction to engage said rotating gear, and moves in an opposite direction to disengage said rotating gear.

7. An interlock for a lifting device as described in claim 1, wherein said electrically operated actuator is connected to said spring biased and pivoting pawl by a linkage, and where said electrically operated actuator moves in a first direction to engage said rotating gear, and moves in an opposite direction to disengage said rotating gear.

8. An interlock for a lifting device as described in claim 1, wherein said rotating gear, said spring biased and pivoting pawl and said electrically operated actuator are mounted to a base plate.

9. An interlock for a lifting device as described in claim 1, wherein said spring biased and pivoting pawl has a pin extending outwardly therefrom.

10. An interlock for a lifting device as described in claim 3, wherein said spring biased and pivoting pawl has a pin extending outwardly therefrom, and wherein said pin is positioned opposite said pivot point from said tail.

11. An interlock for a lifting device as described in claim 3, wherein said spring biased and pivoting pawl has a handle formed at an end thereof that is opposite said pivot point from said tail.
